(19) United States
(12) Patent Application Publication
(10) Pub. No.: US 2002/0059341 A1
(43) Pub. Date: May 16, 2002

(54) System, method and computer program product for displaying and editing advertisement documents

(76) Inventor: Mark William Harrison, Aurora, CO (US)

Correspondence Address: DORSEY & WHITNEY, LLP, SUITE 4700, 370 SEVENTEENTH STREET, DENVER, CO, 80202-5647, US

(21) Appl. No.: 09/872,726

(22) Filed: May 31, 2001

Related U.S. Application Data
(63) Continuation-in-part of application No. 09/733,398, filed on Dec. 8, 2000.
(60) Provisional application No. 60/170,167, filed on Dec. 10, 1999.

(51) Int. Cl. G06F 15/00

(52) U.S. Cl. 707/505

(57) ABSTRACT

A method, system, and computer program product for quickly and easily displaying and editing documents, such as advertisements. A set of master documents of advertising materials is provided, and a set of read-only documents is also provided, wherein the read-only documents are accessible from a network site by a browsing program operable on the user's computer. Preferably, each read-only document is a copy of a respective master document, and is associated with a graphical tool or editing program for editing the respective master document. The browsing program is launched and a first read-only document is accessed across the network and displayed in the browsing program. If the user selects the read-only document for editing, the corresponding master document is transferred from the network site to the user's computer system. The user may then launch a graphical tool or editing program capable of reading the master document. The master document is loaded in the graphical tool or editing program for editing by the user.

### REFERENCE TO RELATED APPLICATIONS

This application claims priority to U.S. patent application Ser. No. 09/733,398, entitled “System, Method and Computer Program Product for Displaying and Editing Advertisement Documents,” filed Dec. 8, 2000, naming Mark W. Harrison as inventor, the disclosure of which is incorporated by reference herein in its entirety.

### FIELD OF THE INVENTION

This invention relates to a system, method and computer program product for displaying and editing advertisement documents.

### BACKGROUND OF THE INVENTION

Advertisement materials for companies, such as banks or other financial institutions, include materials such as stylized brochures, print advertisements suitable for printing in a newspaper, text for radio advertisements, and the like. These materials are generally prepared by various specialized “outside” companies, such as advertising agencies, using writers, graphic artists or other professionals. For a company such as a bank, the process of creating, editing, and finalizing an advertisement can be expensive and time consuming, particularly where the bank does not have a sophisticated graphic designer “in-house.”

What is needed is a system, method, and computer program product for easily creating and editing documents, such as advertisements, “in-house” within a company without the need for an “outside” company, such as a graphic designer or advertising agency, to create and edit the document.

### SUMMARY OF THE INVENTION

According to one broad aspect of the invention, disclosed herein is a system, method, and computer program product, for displaying and editing advertisement documents, which permits a company to perform these functions “in-house.” Generally, the method includes the steps of providing a set of master documents of advertising materials accessible across a network to the user's computer system. The master documents can be a set of documents, or a library of documents, relating to a field of business, such as print, radio text, or other advertisements for the banking industry, for example.

A set of read-only pages or documents is also provided, wherein the read-only documents are accessible by a browsing program operable on the user's computer. Preferably, each read-only page is a copy of a respective master document, and is associated with a graphical tool or editing program for editing the respective master document. The browsing program is launched and a first read-only document is accessed across the network and displayed in the browsing program. The read-only document may be directly accessed by specifying the proper network address, or may be reached through a series of web pages interconnected by hyperlinks.

If the user selects the read-only document for editing, the corresponding master document is transferred from the network site to the user's computer system. The user may select from among multiple master documents in order to choose a master document compatible with his operating system. Once downloaded, the user may then launch a graphical tool or editing program capable of reading the master document. The master document is loaded in the graphical tool or editing program for editing by the user.

### BRIEF DESCRIPTION OF THE DRAWINGS

FIG. 1 is a flowchart illustrating the logical operations performed by one embodiment of the present invention for displaying and editing advertisement documents.

FIG. 1A is a flowchart continuing the illustration of logical operations performed by one embodiment of the present invention for displaying and editing advertisement documents.

FIG. 1B is a flowchart continuing the illustration of logical operations performed by one embodiment of the present invention for displaying and editing advertisement documents.

FIG. 2 illustrates the exemplary steps performed to create a computer program product, such as a CD-ROM, containing the files for performing the logical operations of one embodiment of the present invention.

FIG. 3 illustrates an example of a computer display showing an opening page of library of advertisement documents displayed within a browsing program in accordance with one embodiment of the present invention.

FIG. 4 illustrates an example of a computer display showing a library of advertisement documents organized by subject matter and displayed within a browsing program with top-level links in accordance with one embodiment of the present invention.

FIG. 5 illustrates an example of a computer display showing a library of advertisement documents organized by subject matter and displayed within a browsing program in accordance with one embodiment of the present invention.

FIG. 6 illustrates an example of a computer display showing a particular sub-library of advertisement documents displayed within a browsing program in accordance with one embodiment of the present invention.

FIG. 7 illustrates an example of a computer display showing an opening page of library of advertisement documents displayed within a browsing program in accordance with one embodiment of the present invention.

FIG. 8 illustrates an example of a computer display showing a read-only advertisement document displayed within a browsing program in accordance with one embodiment of the present invention.

FIG. 9 illustrates an example of a computer display showing a master advertisement document displayed within a browsing program in accordance with one embodiment of the present invention.

FIG. 10 illustrates an example of a computer display showing a read-only advertisement document displayed within a browsing program in accordance with one embodiment of the present invention.

FIG. 11 illustrates an example of a computer display showing a master advertisement document displayed within a browsing program in accordance with one embodiment of the present invention.

### DETAILED DESCRIPTION OF A PREFERRED EMBODIMENT

Disclosed herein is a system, method, and computer program product, for displaying and editing advertisement documents, which permits a company to perform these functions “in-house”. Generally, the method includes the steps of providing a set of master documents of advertising materials accessible to the user's computer system. With reference to the present embodiment, the user's computer system may remotely access the set of master documents across a network. As used herein, the term “master documents” includes documents which have been created as a template having textual and/or graphical content which is intended to be revised by a user to suit the user's particular needs. The master documents can be a set of documents, or a library of documents, relating to a field of business, such as print, radio text, or other advertisements for banking.

A set of read-only pages accessible by a browsing program operable on the user's computer is provided, wherein each read-only page is a copy of a respective master document. As used herein, the term “browsing program” refers to any application capable of opening and displaying a master or read-only document. Browsing programs may vary depending on the embodiment. For example, a browsing program used with an embodiment retrieving documents across a network may include an Internet-enabled World Wide Web (WWW) browser, while alternative embodiments may employ browsing programs such as a word processing program or ADOBE ACROBAT™ Reader. Further, multiple browsing programs may be used with a single embodiment. For example, a web browser may be used as a browsing program to view read-only documents across a network, while ADOBE ACROBAT™ Reader may be used to view locally stored documents, or to view additional documents stored on the network. The term “network” as used herein refers to any type of distributed computer or client/server network, such as the Internet, the World Wide Web (WWW), an intranet, a local area network (LAN), wide area network (WAN), and so forth.

Each read-only page is associated with a respective master document and with a graphical tool or editing program for editing the respective master document. The browsing program is launched and a first read-only page is displayed in the browsing program. If the user selects the read-only page for editing, the user may download or otherwise access the corresponding master document via the browsing program by selecting the appropriate icon for the user's operating system from a contents web page (or other network site) listing the selected document script number and title. The master document and any related graphical files incorporated therein are then downloaded to a user specified directory destination on a client or network hard drive. The master document and its related files may then be accessed by launching the appropriate graphical tool or editing program.

In this manner, a user can utilize the browsing program as a browsing, navigational and searching tool for quickly reviewing and moving through a large number of documents. When the user has selected a particular document for editing, the selected document may be easily downloaded and subsequently accessed by the appropriate graphical tool program or editing program.

The user can then edit the advertisement document by, for example, changing the text (i.e., changing the bank name from a sample bank name to the name of the user's bank); changing a graphical image (i.e., changing the bank logo from a sample bank logo to the logo of the user's bank); changing a photo image (i.e., changing a sample photo of a fictitious bank president to the photo of the actual bank president of the user's bank); or changing the data displayed in the advertisement (i.e., changing the loan interest rate from a sample loan interest rate to the actual loan interest rate offered by the user's bank).

All of the components for performing the above-described steps may be provided as a downloadable file or files from a web site or other network site, such as a file transfer protocol (FTP) location. This permits the user to easily and quickly browse through the master documents containing various advertisements, and selectively edit, save and print the edited advertisement. Appendix A contains 7 sheets of a description of one example of a product made in accordance with one embodiment of the present invention, wherein the product is stored on a network site as a set of HTML files. Alternative embodiments may supply the necessary components on a CD-ROM or other computer readable medium.

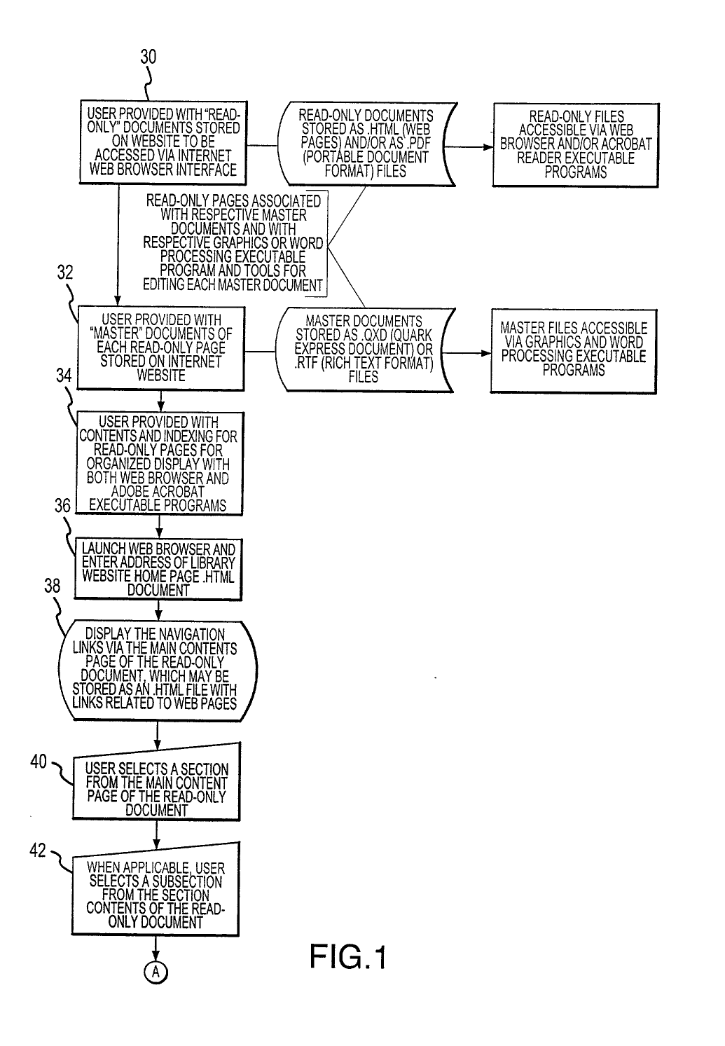

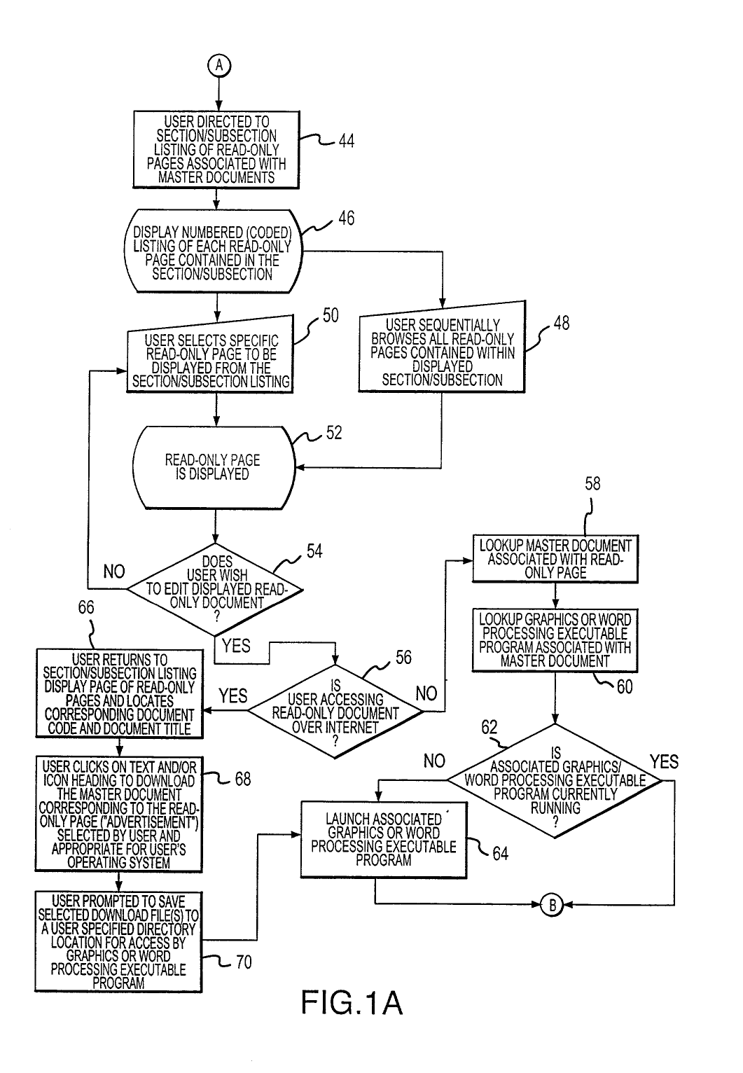

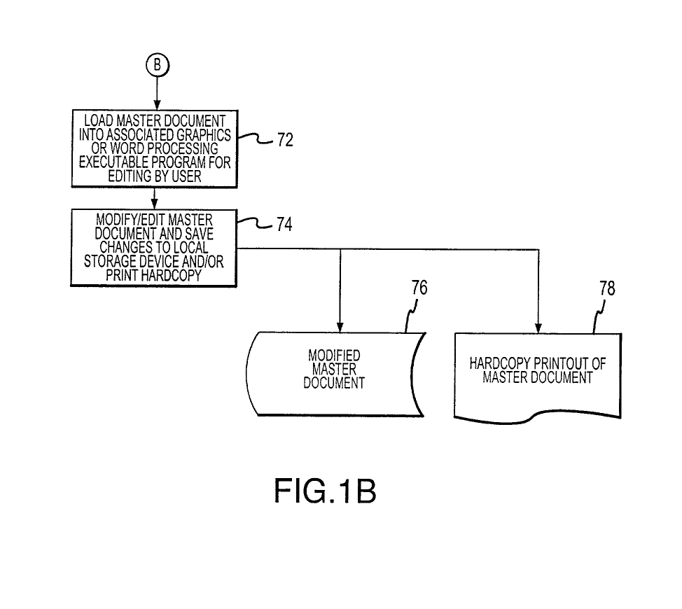

Referring to FIGS. 1-1B, the logical operations performed by one embodiment of the present invention for displaying and editing advertisement documents are illustrated. Beginning with operation 30 of FIG. 1, a read-only version of the advertisement document is provided to the user, for example, on CD-ROM or via a user-accessible network site. The read-only document may be stored as a PDF (portable document format) file, accessible via a browsing program such as ADOBE ACROBAT™ Reader. Read-only documents may also be stored as hypertext markup language (HTML) files to be retrieved and displayed via a browsing program such as a web browser. Alternative embodiments may store the read-only documents in other browser-compatible formats, such as server HTML (SHTML), extensible markup language (XML), and so forth. Further, the read-only documents need not all be stored in a single file format, but may be some mixture of the above.

At operation 32, the user is provided with “master” documents of each read-only page. Again, these master documents may be provided either via computer-readable medium or as a downloadable file or files from a network site.

The read-only pages are associated with a respective master document and with a respective graphical tool for word processing editor for editing each master document. The master documents may be stored, for example, as QUARK XPRESS documents or RTF (rich text format) files. The master documents are accessible via the graphical tools and word processing programs, as will be explained below.

At operation 34, the user is provided with contents and indexing for the read-only pages so that the read-only pages are displayed in an organized manner within the browsing program, generally either ADOBE ACROBAT or a web browser. An example of this indexing is shown and described in the attached Appendix A. At operation 36, the browsing program is launched and an initial read-only file is opened which provides the user with a top level navigation throughout the various read-only documents. In the present embodiment, the read-only file may be accessed by inputting the network address (such as a uniform resource locator, or URL) into the browsing program, thus directing the program to seek the read-only file at the specified network location.

At operation 38, navigational links are displayed on a main contents page, which assists the user in navigating through the various read-only documents. In the present embodiment, the contents page may be stored in HTML format on the network site.

At operation 40, the user selects a section from the main contents page for viewing. The section can be, for example, a topical subdivision of the documents as organized by indexing. At operation 42, when applicable, the user selects a subsection from the section contents of the read-only document. It is understood that operations 40-42 are optional depending upon how the read-only documents are organized on the computer program product, for example as a set of HTML files stored on a network site and interconnected by hyperlinks.

At operation 44 (shown on FIG. 1A), the user is directed to the appropriate listing of the read-only documents which the user has selected. At operation 46, the user is provided with a listing of each read-only documents/page contained within the user selected section/subsection. At operation 48, the user can sequentially browse all read-only pages contained within the display. The user then at operation 50 selects a particular read-only page/document to be displayed on the computer screen, and at operation 52, the appropriate read-only page/document is displayed within the browsing program. At this point the user can quickly navigate and view a variety of different read-only documents using the browsing program.

At decision operation 54, if the user wishes to edit the displayed read-only document, then operation 56 determines whether the user is accessing the read-only document across the Internet or other network. If so, operation 66 is executed as described later. Otherwise, operation 58 retrieves the master document associated with the particular read-only page. In one example, the user indicates his/her desire to edit the read-only documents by mouse-clicking on the read-only document displayed within the browsing program. If the user has so selected the document for editing, operation 60 looks up the graphical tool or word processing program associated with the master document, so that this program can be launched if not already running on the user's computer system, as determined by decision operation 62. If appropriate, operation 64 launches the associated graphical tool or word processing editing program at the user's computing station. Otherwise, operation 72 is accessed, as described below.

Returning briefly to operation 56, it may be determined that the user is accessing the read-only document across a network. If so, then operation 66 returns the user to a section/subsection listing display page showing all read-only pages stored on the network side. As part of the same operation, the user may locate the corresponding document code and title. In operation 68, the user specifies the read-only page desired for editing. Operation 68 then downloads the master document corresponding to the read-only page selected by the user to the user's computer. In the present embodiment, the user may also specify as part of operation 68 the version of the master document appropriate for the user's operating system (for example, IBM™ PC or APPLE MACINTOSH™ compatible). At operation 70, the user is prompted to save the selected downloadable files to a user-specified directory in order to allow access by an associated graphical tool or word processing/editing program. Following operation 70, operation 64 is executed, with results as discussed above.

Turning now to FIG. 1B, operations 72 through 78 are discussed. At operation 72 the master document, corresponding to the read-only page/document, is loaded into the proper graphical tool or word processing/editing program, so that the user can then edit the document as desired. At operation 74, the user modifies or edits the master document and can save any changes to the master document to a local storage device, if desired. Operations 76 and 78 show that the user can modify or print the master document as revised by the user in operation 74.

The above computer implemented steps in another implementation of the invention are provided as an article of manufacture, i.e., a computer storage medium such as a CD-ROM, containing a computer program of instructions for performing the above-described steps.

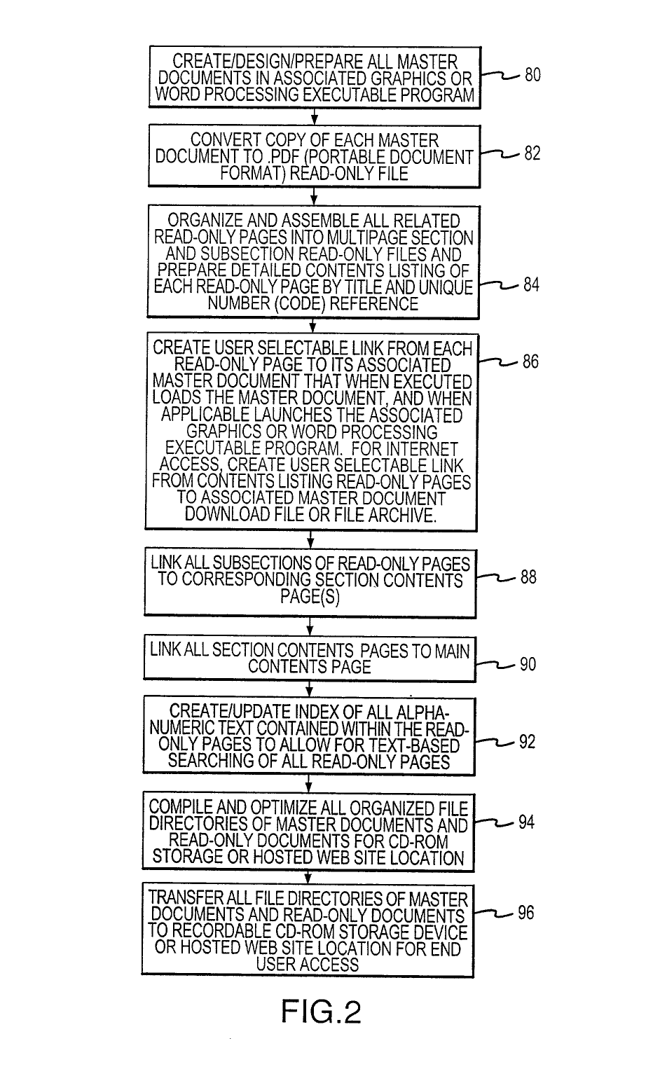

Referring now to FIG. 2, the exemplary steps performed to create a computer program product, such as network site containing the files for performing the logical operations of an embodiment of the present invention, are illustrated. At operation 80, the master documents are created, designed, and prepared in a graphical tool program or a word processing program. These documents are then converted into a format readable by the browsing program, such as the PDF or HTML formats, as shown in operation 82. At operation 84, the read-only pages are organized and assembled into sections and subsections and provided with appropriate indexes for document titles or codes as desired. At operation 86, each read-only page is associated with one or more master documents or compressed data files, which may contain the master document and/or integrated graphic component files such as illustrated artwork, logos, photos, and images which are required for display and/or output of an advertisement. Sample compression formats used to compress data files include ZIP, TAR, UUE, base 64, BinHex, and so forth. With respect to the present embodiment, a user selectable link, such as a hyperlink, may direct the user from the appropriate index to the associated master document downloadable file (or file archive).

The read-only pages can then be arranged for an organized display within the browsing program. Operation 88 links all of the read-only pages to their proper section and subsection, for purposes of organization within the browsing program. Operation 90 links the section contents page, to the main contents page. It is understood that operations 88-90 are optional operations which are provided for organizing the read-only documents within the browsing program.

A further optional feature which can be provided is a searchable text feature. Operation 92 creates an index of all alphanumeric text contained within the read-only pages to allow for text based searching of these pages within the browsing program, such as ADOBE ACROBAT™.

At operation 94, the files, including the master documents and the read-only documents, are compiled and optimized for storage onto the computer program product, such as a CD-ROM or network site. At operation 96, the file directories of the master documents and the read-only documents are transferred to a recordable CD-ROM storage device or hosted web site, which may or may not be the same as the aforementioned network site.

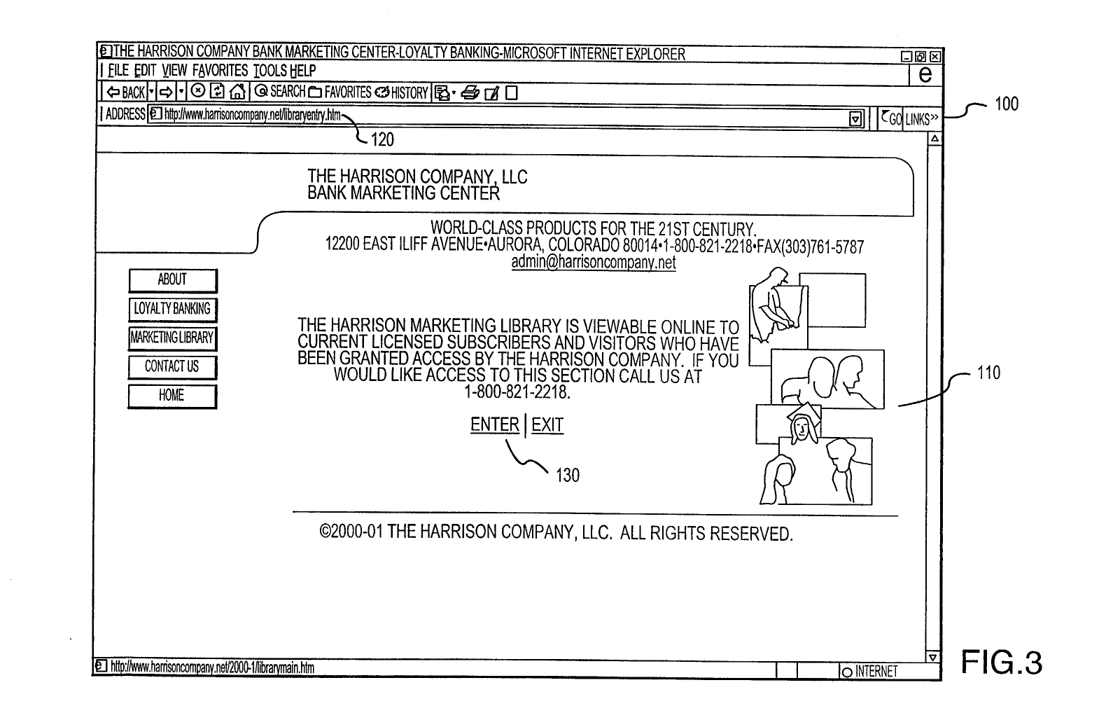

Referring to FIGS. 3-18, examples of computer displays showing various features of embodiments of the present invention may be seen. In particular, FIG. 3 illustrates a web browser 100, such as MICROSOFT INTERNET EXPLORER™ or NETSCAPE™. The web browser displays a web page 110 corresponding to a network address 120. The top-level web page for any given network site is typically referred to as a “home page.” The web page 110 may contain hyperlinks such as link 130, which permits a user to access additional web pages stored on the network site. In the present embodiment, clicking on or otherwise selecting the link 130 prompts the embodiment to display a pop-up box requesting a user name and password, thus allowing only authorized users entry to additional web pages. Alternative embodiments may omit the user name and password requirements.

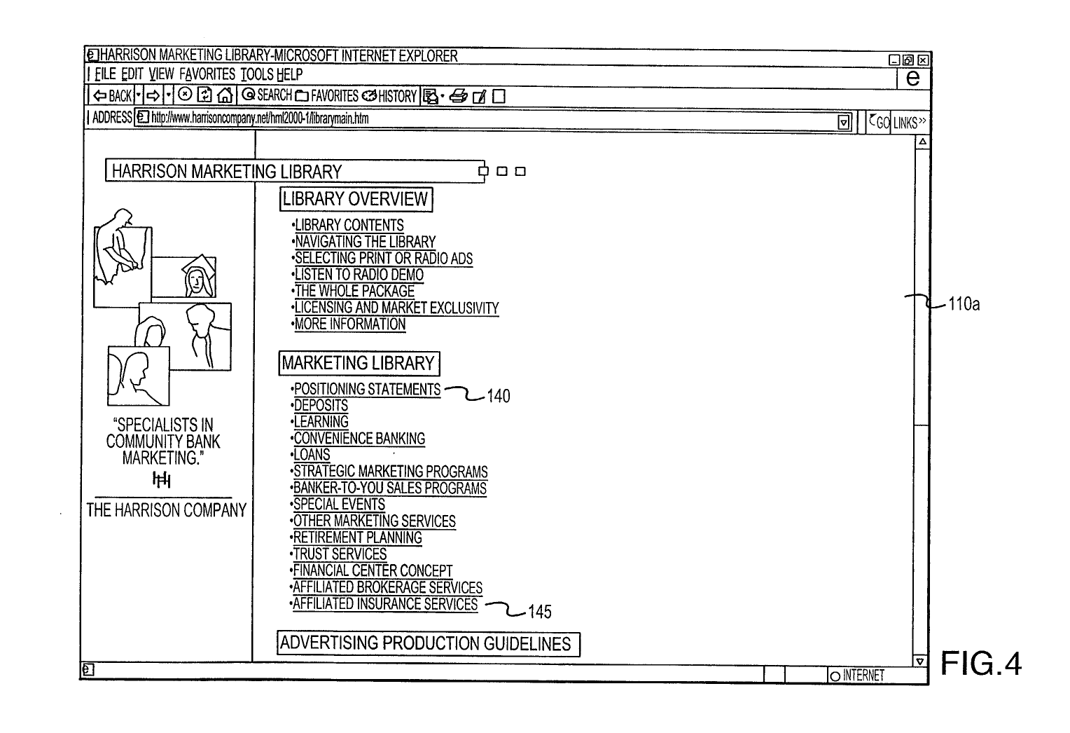

Once the user selects link 130 and enters any required identifying information, he is taken to web page 110a. FIG. 4 displays a specific web page employed by the present embodiment; alternative embodiments may use different web pages, or may permit a user to jump directly from a home page or other web page 110 directly to a downloadable file. Generally speaking, however, the web page 110a typically contains one or more hyperlinks 140 which permit a user to view a library of downloadable master documents. Each library is an organization of master documents corresponding to a specific theme, or of sub-libraries corresponding to the theme. For example, the “Positioning Statements” library reached via library hyperlink 140 contains sub-libraries housing advertising directed at positioning an advertiser within the relevant community. Similarly, the “Affiliated Insurance Services” hyperlink 145 may lead to a library containing master documents or sub-libraries dealing with advertisements for insurance services offered by a user.

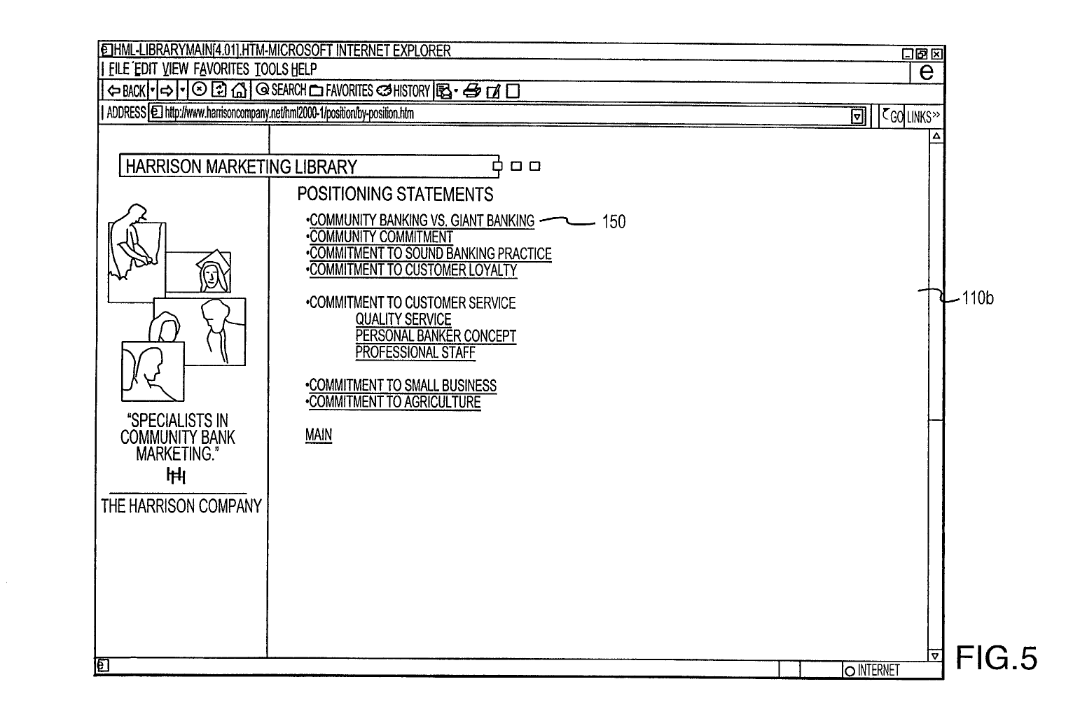

FIG. 5 displays a web page 110b containing the “Positioning Statements” library, accessible via hyperlink 140 (shown on FIG. 4). The “Positioning Statements” library may be further divided into sub-libraries, again accessible by selecting a hyperlink 150.

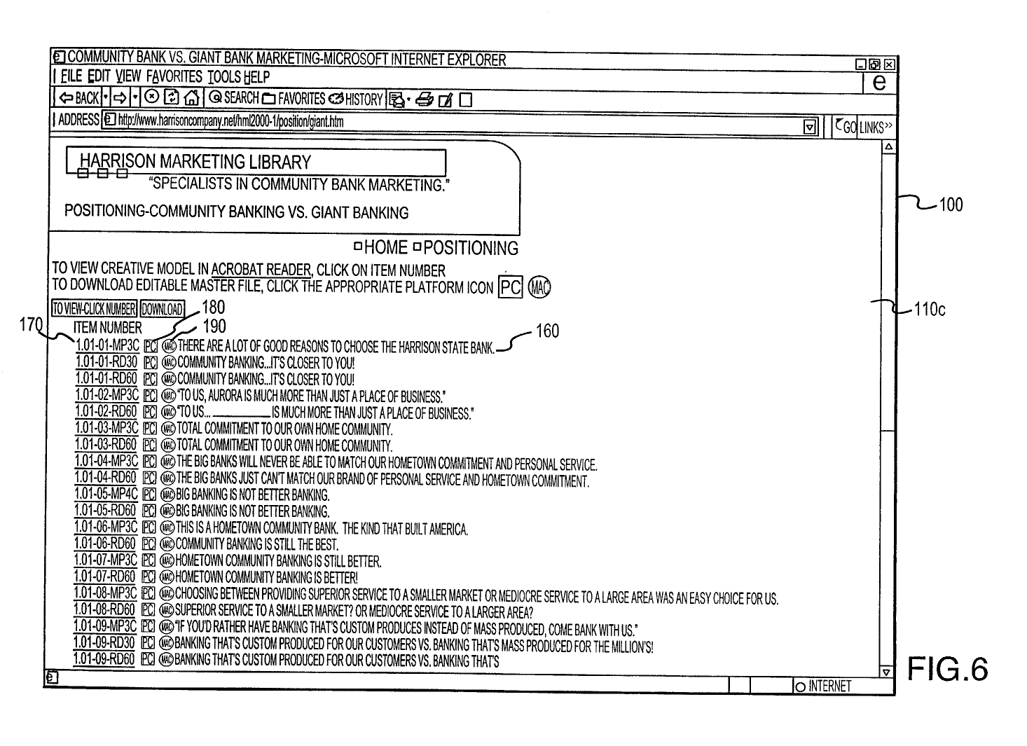

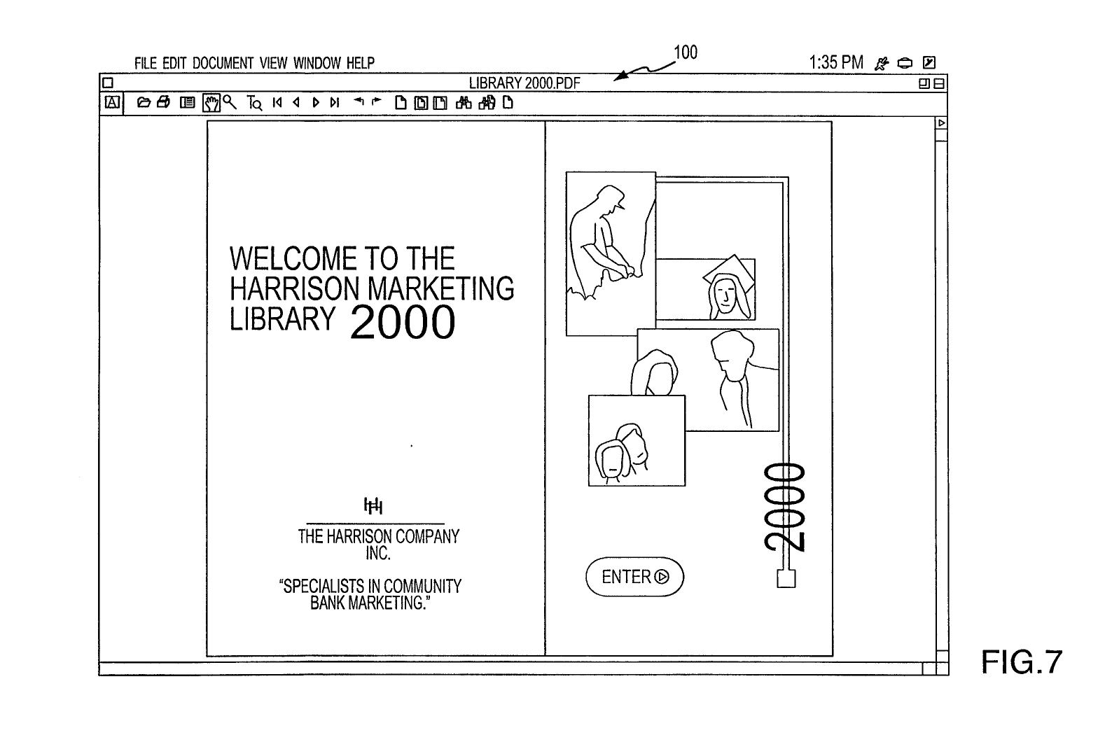

Selecting the “Community banking vs. Giant banking” hyperlink 150 causes another web page 110c to display in the web browser 100. As can be seen in FIG. 6, the web page 110c contains a list of various advertising documents 160. Each advertising document 160 typically corresponds to three hyperlinks: a view hyperlink 170, a PC master document hyperlink 180, and a MAC master document hyperlink 190. Clicking the view hyperlink 170 opens the read-only file in a browsing application, either the web browser 100 itself or an external application such as ADOBE ACROBAT™ Reader. An example of a read-only file displayed in an external application may be seen in FIG. 7, discussed below. Clicking the PC master document hyperlink 180 instructs the embodiment to transfer an IBM personal computer compatible master document across the network, from the network site to the user's computer system. Similarly, clicking the MAC master document hyperlink 190 initiates transfer of an APPLE MACINTOSH™ compatible master document across the network. Typically, a transferred document is stored on the user's computer system.

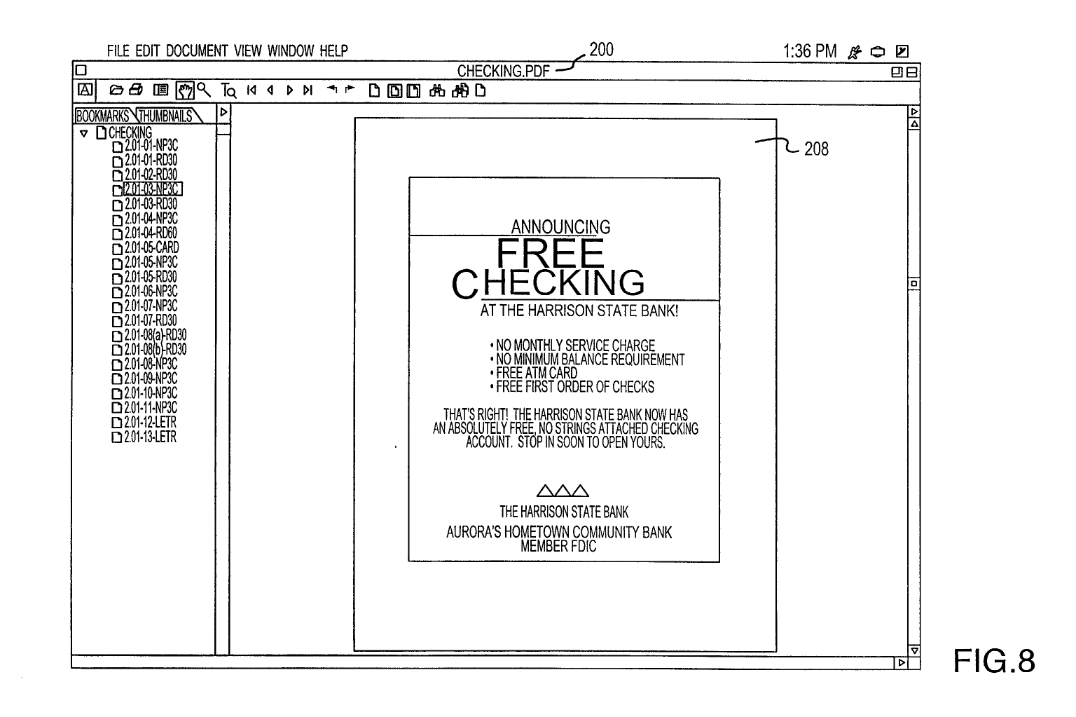

In the event that the read-only documents are provided on a computer-readable medium such as a CD-ROM, rather than as files stored at a network site, the browsing program 100 is typically not a web browser, but instead an application such as a word processing program or ADOBE ACROBAT™. FIG. 8 displays a read-only document retrieved from a CD-ROM and shown in a browsing program 100.

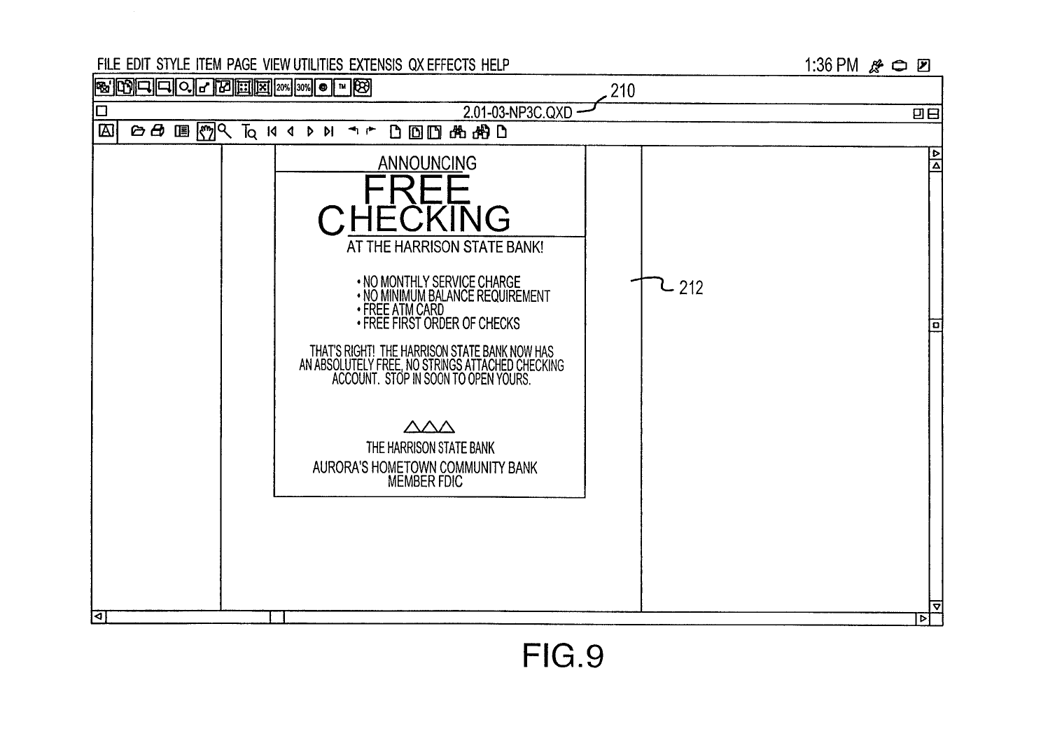

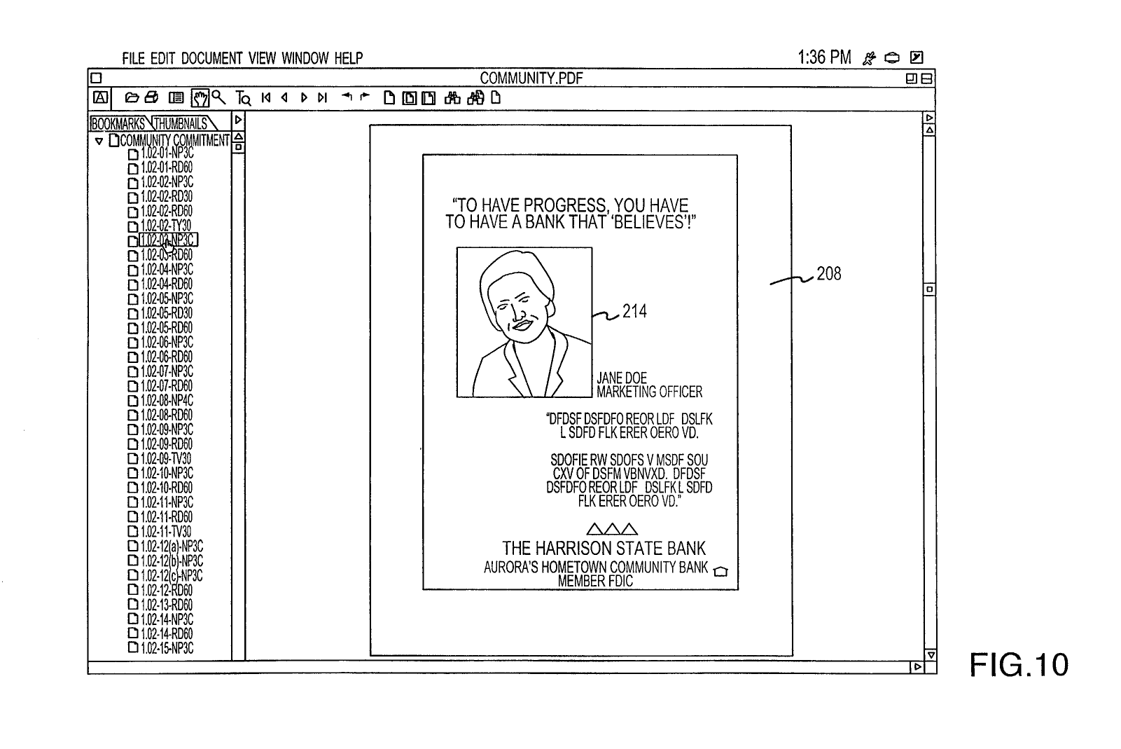

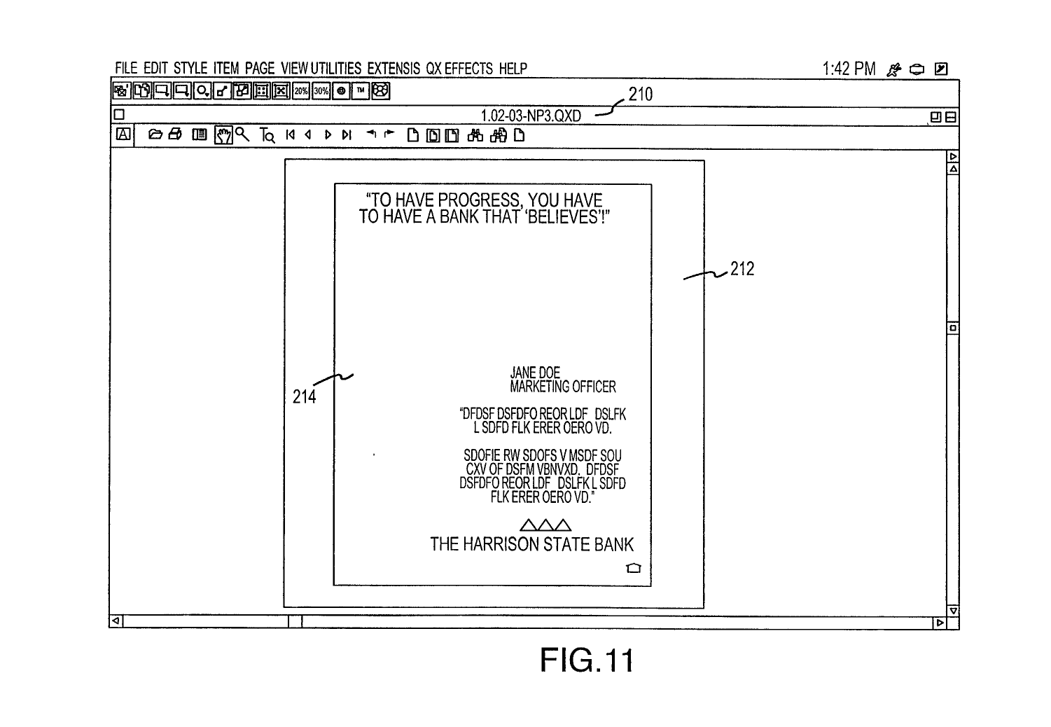

Once downloaded from the network, the user may edit or otherwise access the master document as necessary. Viewing of a downloaded master document is typically carried out with a browsing program such as ADOBE ACROBAT™. Upon the user selecting (i.e., mouse-clicking onto a read-only document 208), the graphical tool/editing program 210 associated with the read-only document 208 is launched, as shown in FIG. 9. The graphical tool/editing program 210 is automatically loaded with the master document 212, as shown in FIG. 9. The user can then edit the document 212 within the graphical tool/editing program 210. These edits can include, for example, changing the text (i.e., bank name), graphical images (i.e., bank logo), or photographic image 214 as shown in FIGS. 10-11.

While the invention has been particularly shown and described with reference to a preferred embodiment thereof, it will be understood by those skilled in the art that various other changes in the form and details may be made without departing from the spirit and scope of the invention. For example, it is understood that the above-described methods could be used to permit a user to review and edit other documents in general, regardless of whether the documents are advertising documents for banks or financial institutions. Likewise, although the foregoing was described with respect to multiple web pages containing libraries and sub-libraries, alternative embodiments may contain fewer or more web pages, or may permit direct access to downloadable master documents, without departing from the spirit or scope of the invention.

We claim:

1. A method for displaying and editing advertisement materials across a network, comprising:
providing a set of master documents of advertising materials accessible across a network by a user;
providing a set of read-only pages accessible by a browsing program operable on the user's computer, each read-only page being a copy of a respective master document;
associating each read-only page with a respective master document;
in response to a user-initiated signal, displaying a first read-only page in a browsing program;
if the user selects the read-only page for editing, transmitting a master document associated with the read-only page across the network to the user; and
storing the master document on a user's computer system.

2. The method of claim 1, wherein the step of transmitting a master document associated with the read-only page across the network to the user comprises:
determining the operating system employed by the user; and
in response to determining the operating system employed by the user, selecting a master document corresponding to the operating system from among a plurality of master documents.

3. A computer-readable medium containing instructions which, when executed, performs the method of claim 2.
